(19) United States
(12) Patent Application Publication
(10) Pub. No.: US 2025/0381098 A1
(43) Pub. Date: Dec. 18, 2025

(54) MULTILAYER GAS BARRIER FILM AND BAG

(71) Applicant: FRESENIUS MEDICAL CARE DEUTSCHLAND GMBH, Bad Homburg (DE)

(72) Inventors: Sebastian WIEGAND, Bad Homburg (DE); Tim NIKOLAUS, Bad Homburg (DE)

(73) Assignee: FRESENIUS MEDICAL CARE DEUTSCHLAND GMBH, Bad Homburg (DE)

(21) Appl. No.: 19/116,395

(22) PCT Filed: Oct. 4, 2023
(86) PCT No.: PCT/EP2023/077398

§ 371 Date: Mar. 28, 2025

(30) Foreign Application Priority Data
Oct. 5, 2022 (DE) 10 2022 125 603.0

(51) Int. Cl. A61J 1/14; A61J 1/10; B32B 27/08; B32B 27/32; B32B 27/34; B32B 27/36; B65D 65/40

(52) U.S. Cl. CPC A61J 1/1468; A61J 1/10; B32B 27/08; B32B 27/32; B32B 27/34; B32B 27/36; B65D 65/40; B32B 2250/03; B32B 2250/24; B32B 2255/10; B32B 2255/20; B32B 2307/7244; B32B 2307/7246; B32B 2307/7376; B32B 2439/06; B65D 2565/387

(57) ABSTRACT

Multi-layer gas barrier film for containing medical fluids, comprising an inner film having a first and a second surface, the first surface being in contact with the fluid and the second surface being in contact with a first adhesion agent, a middle film having a third and a fourth surface, the third surface being in contact with the first adhesion agent and the fourth surface being in contact with a second adhesion agent, an outer film having a fifth and sixth surface, the fifth surface being in contact with the second adhesion agent, where the inner film comprises an olefinic polymer having a glass transition point of less than 10° C. and a melting point of above 130° C., where the middle film has a polymer having an ester bond and a glass transition point of above 35° C. and a melting point above 150° C., and the middle film comprises an inorganic gas barrier material, and where the outer film comprises a polymer having an amide bond.

### TECHNICAL FIELD

The invention relates to a multi-layer gas barrier film for containing medical fluids. The invention further relates to a bag for containing medical fluids, comprising a multi-layer gas barrier film.

### BACKGROUND

Gas barrier films and gas barrier bags are needed, for example, for the provision of bicarbonate-buffered medical fluids, particularly dialysis solutions for peritoneal dialysis, acute dialysis, and dialysis for the treatment of chronic kidney failure by means of haemodialysis. For these purposes it is necessary in particular for such gas barrier bags to have a low carbon dioxide permeation tendency. Furthermore, such gas barrier bags may also be suitable for containing enteral or parenteral nutrient solutions and suspensions.

Generic barrier films and bags are known, for example, from DE102012018525A. In that case a polyester or polyamide film is coated with a ceramic coating material and the coated surface is subsequently laminated with a polyolefin film, without any adhesion agent being used to bond the two films. Films produced in this way are limited in their laminate strength and also in the tear strength of the multi-layer film. In addition, the production of seams known as peel seams, these being seams which are introduced into the multi-layer bag in order for different solutions to be contained in one bag, and which are pulled open before the solutions are used, to allow the solutions to mix in the bag, is more difficult.

EP0760283A describes a multi-layer film comprising a polyester or polyamide base material provided with an inorganic SiO2 layer, the film comprising a second barrier layer made from PVC or a similar material. The adhesion of the barrier film to the inorganic SiO2 layer is said to be ensured by a saline treatment of the inorganic layer. Multi-layer films of this kind exhibit good water and oxygen barrier properties, but may not be sufficiently stable mechanically to allow medical fluids to be reliably stored. In addition, such films are difficult to weld, and so the resulting weld seam strength may be low. Depending on the layer sequence, these films also exhibit poor values for the leachability for example of residue monomer constituents such as caprolactam, for example.

Further composite systems are described in EP0792846B, which provides for the coating of a base film with a so-called ormocer, i.e. an organic-inorganic hybrid layer. For the production of a gas barrier film, however, production processes of this kind are very costly and inconvenient, as they necessitate the use of a process known as a sol-gel process, which runs counter to the efficient production-scale coating of a film. It is difficult, moreover, to provide suitable gas barrier properties particularly for carbon dioxide.

EP1028994B1 describes a two-layer film which comprises an oriented polyamide film, coated with an inorganic silicon oxide layer, and a sealing layer. Such films have restricted retention of residual monomers and may have little mechanical robustness.

### OBJECT OF THE INVENTION

The object on which the invention is based is therefore that of reducing the disadvantages of the prior art. An object in particular is to ensure a mechanically stable film featuring low transmission of residual monomers and other unwanted substances to the medical fluid. A further object is to provide a bag, comprising a film of the invention that reduces the disadvantages of the prior art.

### SUMMARY OF THE INVENTION

The object is achieved in accordance with the invention, according to a first aspect of the invention, by the provision of a multi-layer gas barrier film for containing medical fluids, comprising an inner film having a first and a second surface, the first surface being in contact with the fluid and the second surface being in contact with a first adhesion agent, a middle film having a third and a fourth surface, the third surface being in contact with the first adhesion agent and the fourth surface being in contact with a second adhesion agent, an outer film having a fifth and sixth surface, the fifth surface being in contact with the second adhesion agent, where the inner film comprises an olefinic polymer having a glass transition point of less than 10° C. and a melting point of above 130° C., where the middle film has a polymer having an ester bond and a glass transition point of above 35° C. and a melting point above 150° C., and the middle film comprises an inorganic gas barrier material, and where the outer film comprises a polymer having an amide bond.

A medical fluid of this kind may be a solution, more particularly an aqueous solution, comprising optionally ionic and/or nonionic, water-soluble components; further, in particular, the medical fluid may comprise carbonatic components. A multi-layer film of this kind is also used preferentially for medical fluids which react sensitively to the ingress of atmospheric carbon dioxide into the fluid. In the context of containment of carbonate-containing or hydrogencarbonate-containing solutions, it may also be desirable to minimise the loss of carbonate or hydrogencarbonate ions from the solution.

A multi-layer film of this kind exhibits good mechanical stability, thereby ensuring the trouble-free preservation of medical fluids over a relatively long period. In particular it is possible to handle the bag under exacting conditions, in a hospital, for example, without the bag being mechanically damaged or, for example, tearing. It is ensured, moreover, that the residual monomers, which are present in particular with polymers having an amide bond, are not able to diffuse critically through the multi-layer film and get into the medical fluid. It is ensured, moreover, that the diffusability for carbon dioxide through the multi-layer gas barrier film is particularly low. Because the inner surface comprises an olefinic polymer, it is particularly easy to provide the film with a peel seam. A peel seam may be accomplished simply by welding an area with defined temperature, so that the multi-layer film on the one hand can be processed to a multi-chamber bag with different medical fluids, while on the other hand it is made possible for the peel seam to be broken before the medical fluids in the respective chambers are used and for the mixing of different medical fluids shortly before use to be enabled. This is desirable essentially when medical fluids have a long storage life as separate solutions but exhibit only limited keeping properties after mixing. Olefinic polymers are preferred in direct contact with medical fluids, moreover, since they are physiologically unobjectable to a particular degree. Multi-chamber bags of this kind are used in particular for containing medical dialysis solutions, and also, in particular, for dialysis solutions for peritoneal dialysis.

In one embodiment the multi-layer gas barrier film is characterized in that the polymer having the amide bond has a glass transition point of 60 to 100° C. in the dried state and/or a glass transition point of 20 to 60° C. in the water-saturated state and a melting point greater than 200° C. Having emerged as being particularly suitable for the provision of a multi-layer gas barrier film are hygroscopic polyamides which are characterized in that the glass transition point falls through absorption of water after the extrusion of the film. Prior to processing to a film, the polyamide material must be dried sufficiently to leave a residual moisture content of less than 0.1%. After processing to a multi-layer gas barrier film and production of a bag for medical fluids, especially aqueous fluids, the polymer is able to absorb water up to saturation, so resulting in a preferred profile of mechanical properties of flexibility and strength. Examples of such polyamides are polyamide 6 or polyamide 4.6 or 6.6. The glass transition point here is ascertained using the DSC method, as indicated in the description below. Particularly suitable polyamides have a melting point of less than 250° C. The polyamides are preferably aliphatic. One particularly preferred polyamide is polyamide 6, as it is available widely and inexpensively and has a particularly preferred profile of properties in terms of the mechanical properties.

According to one development of the invention, the multi-layer gas barrier film is characterized in that the middle film with ester bond has an inorganic gas barrier layer on at least one surface of the polymer and in that the third or fourth surface is formed by the inorganic layer.

Films of this kind with ester bonds can be produced on the industrial scale: one corresponding production method is described in DE102012018525A. It is important here that the inorganic gas barrier layer can be applied particularly effectively on the film with ester bond so that the adhesive strength is good. Important in particular in this context is the combination of the polymer with ester bond on the one hand, which exhibits a particularly good diffusion barrier to carbon dioxide, and, on the other hand, the inorganic layer with the generally good barrier effect to all gases such as water vapour, oxygen and carbon dioxide, for example.

In one particular embodiment the middle film of the multi-layer gas barrier film has inorganic layer particles of SiOx. These particles are readily producible in accordance with DE102012018525A and offer a particularly good adhesive strength on the polymer with ester bond, in conjunction with good gas barrier properties.

In one embodiment of the invention the multi-layer gas barrier film is characterized in that the middle film comprises a polyethylene terephthalate or a polyethylene naphthalate or a mixture of both polymers. These polymers have high mechanical robustness, are readily extrudable as film, and have particularly good properties in respect of carbon dioxide diffusion. Polyethylene terephthalate is particularly preferred, since it is able to provide a good adhesive effect for the inorganic layer.

The multi-layer gas barrier film is preferably characterized in that the multi-layer film contains no silane coupling agent. While a silane coupling agent of this type is indeed possible for providing effective composite adhesion between the inorganic layer and, for example, a polyolefin layer, embodiments of that kind are particularly costly and inconvenient to develop and produce. For example, prior to the reaction with the inorganic particles, silane coupling agents must be hydrolysed, in a costly and inconvenient procedure that produces unwanted alcohols, methanol for example, which may be deleterious especially if it passes into medical fluids. Following the silane hydrolysis, the silanol is also required to couple to the inorganic particle, and this represents a comparatively slow reaction. Furthermore, from a large selection of the silanes, it is necessary first to select the silane that is best suited, and this is very costly and inconvenient, depending on the film sequence of the multi-layer film.

According to one embodiment the multi-layer gas barrier film is characterized in that the polymer of the outer film comprises polyamide 6. With particular preference the multi-layer gas barrier film has a leaching of caprolactam, determined by the method indicated in the description, of less than 1 mg/l, preferably less than 0.1 mg/l. Depending on the raw material, polyamide may have an elevated content of caprolactam, in the form of residual monomer content, which is a disadvantage because this residual monomer content may transfer into the medical fluid. This may occur in particular if a bag for containing aqueous medical fluids has been produced from the multi-layer gas barrier film. Through the arrangement according to the invention, it is possible to prevent the possibility of an unallowably high proportion of the caprolactam transferring to the medical fluid.

A multi-layer gas barrier film according to one embodiment may be characterized in that the inner film has a wall thickness of 100 to 250 μm, more particularly of 150 to 200 μm. The wall thickness range is essentially dictated by the need for sufficient strength of the inner film and of the overall film, but the minimum and maximum wall thickness is also determined by the need for welding which arises if the film is to be processed into a bag for containing medical fluids. Particularly if a weld seam with high strength and at the same time a peel seam is to be present, then, as has emerged as part of the studies leading to the invention, the observance of particular wall thickness ranges is preferred.

A multi-layer gas barrier film according to one embodiment may be characterized in that the middle film has a wall thickness of 5 to 30 μm, more particularly of 5 to 20 μm. As well as providing sufficiently high strength, the polymer of the middle film takes on the function of a gas barrier for the gases water vapour, oxygen and especially carbon dioxide. The careful selection of the wall thickness is critical to the target profile of properties made up of strength and diffusion barrier. If the middle film is coated with inorganic particles, the wall thickness specification applies to the coated middle film.

According to a further embodiment, the multi-layer gas barrier film is characterized in that the outer film has a wall thickness of 5 to 30 μm, more particularly of 10 to 20 μm. The wall thickness range of the outer film must be carefully chosen, since it is necessary to ensure a sufficient profile of the properties made up of film flexibility and strength.

In one preferred embodiment the multi-layer gas barrier film is characterized in that the sixth surface is in contact with the surrounding atmosphere. The film in the case of this embodiment is configured such that there is no need for a further layer in order to provide the overall profile of properties.

According to one development of the invention the multi-layer gas barrier film is characterized in that the diffusion of carbon dioxide through the film is less than 20 cm³/m²*d*bar. In the context of the experiments for this invention, it has emerged that the specific layer sequence, especially the selection of the polymer of the middle film using a polymer with ester bond, is important for the provision of a film having low diffusability for carbon dioxide. Especially if the medical fluid contains solids and solutions with carbonate-containing substances, the low diffusability of carbon dioxide is important for sufficient stability of the medical fluid.

According to a second aspect, the object of the invention is ensured through the provision of a bag for containing medical fluids, comprising a multi-layer gas barrier film according to a first aspect of the invention. A bag of this kind is formed, for example, from two film portions, with the surrounding edges being provided with a weld seam. Here it is possible preferentially to use flat films. The use of tubular films may also be preferable, especially if the hygiene requirements imposed on the film are increased. Tubular films are produced with particular preference using water cooling, especially if the films are to have a high transparency. The bag according to the second aspect of the invention is therefore preferably characterized in that the bag comprises a weld seam. In this case, using a welding apparatus, in the surrounding edge region, for example, temperature is introduced into the film portions to an extent such that the inner film of both film portions melts. By joining the film portions, the molecules of the polymer of the inner film may be connected to one another by intertangling, for example. The aim here is to achieve a weld seam strength such that a stable bag is formed which leads to reliable preservation of the medical liquid without the possibility, for example, of the weld seam opening.

A further embodiment of the second aspect of the invention is characterized in that the bag comprises a peel seam. Peel seams can be produced reliably especially when the welding takes place in a manner similar to the firm welding, for example, of the surrounding bag edge, but the temperature and exposure time during welding are lowered to an extent such that there is comparatively weak intertangling of the molecules, and so the weld seam produced is peelable. The presence of firm seams and of peel seams alongside one another in particular is advantageous for the production of a multi-chamber bag with the aid of a film of the invention.

### DETAILED DESCRIPTION OF AN EXEMPLARY EMBODIMENT

### Example 1: Production of the Film

### 1. Production of a Polyolefin Film

A polyolefin film is produced as a three-layer film by tube extrusion, with water cooling being used in order to achieve sufficient transparency. An outer layer of PP homopolymer is used. The layer thickness is 15 μm. The middle layer consists of a 145 μm PP/TPE blend. The inner layer consists of a further PP/TPE blend with increased TPE content. The TPE used is SEBS. The overall thickness of the polyolefin film is 180 μm.

The film is especially suitable for the production of weld seams with different strengths. Hence the outer region of a bag may be made particularly tear-resistant by intense welding, while a multi-chamber bag is provided through provision of an inner peel seam with low tear strength.

### 2. Production of a PA Film

A polyamide film made from polyamide 6 is produced as a cast film with biaxial drawing. The layer thickness is 15 μm.

### 3. Production of a PET/SiOx Film

A cast film of PET with layer thickness 12 μm or of PET/PEN, biaxially drawn, is used. The SiOx layer is applied by electron beam evaporation, with the thickness of the inorganic layer being around 50 nm. The production of the layer is described in more detail in DE102012018525A.

### 4. Production of the Multi-Layer Film by Laminating

The outer layer of the polyolefin film—consisting of polypropylene—is wetted with a solvent-borne polyurethane adhesive and the layer is subjected to primary drying in a heating tunnel. The PET-SiOx layer is laminated onto it in a roller laminator.

This is followed by the application of a further layer of polyurethane adhesive, with further initial drying. The PA film is laminated onto this layer.

### 5. Trimming

The composite film after the laminating procedure is subjected to edge tidying in a roll cutter and the film is cut to size.

### Comparative Example 1: Production of the Film

The multi-layer gas barrier film is produced as in Example 1, with the following difference: The outer layer of the polyolefin film—consisting of polypropylene—is wetted with a solvent-borne polyurethane adhesive and the layer is subjected to primary drying in a heating tunnel. The PA6 layer is laminated onto it in a roller laminator.

This is followed by the application of a further layer of polyurethane adhesive, with further initial drying. The PET-SiOx film is laminated onto this layer. The SiOx layer here comes into contact with the layer of adhesive.

### Comparative Example 2: Production of the Film

A polyolefin film and a PET/SiOx film according to Example 1 are used. The outer layer of the polyolefin film—consisting of polypropylene—is wetted with a solvent-borne polyurethane adhesive and the layer undergoes preliminary drying in a heating tunnel. The PET-SiOx layer is laminated onto this film in a roller laminator.

### Elution Experiment

A solution is prepared which may be suitable for the implementation of peritoneal dialysis. The concentrations are as follows:

| Substance | Value | Unit |
|---|---|---|
| Sodium | 134 | mmol/l |
| Calcium | 1.25 | mmol/l |
| Magnesium | 0.5 | mmol/l |
| Chloride | 103.5 | mmol/l |
| Hydrogencarbonate | 34 | mmol/l |
| D-Glucose | 15 | g/l |
| pH | 7.05 | / |
| Aluminium* | <10 | μg/l |

*The aluminium content is ascertained by the known measurement method of ICP-mass spectroscopy.

A bag is produced from each of the films by firm welding of the edges. In the upper region a filling tube is inserted and is welded tightly, as in the case of the bags available in mass-produced form under the name sleep safe Bica Vera 5000 ml from Fresenius Medical Care.

A bag is produced in the same dimensions as those of the commercially available bag. This bag is filled with 5 1 of the solution stated above.

This bag is then storage-tested at 40° C. and <25% relative humidity for 3 months.

The solution is analysed by gas chromatography for the concentration of caprolactam present.

The conditions for the gas chromatography/MS are as follows:

TABLE 1
Appropriate instrument settings, e.g.

| Parameter | Setting | | |
|---|---|---|---|
| GC | column | Support | Fused silica |
| | | material | |
| | | Immobile | 5% phenyl |
| | | Phase | 95% |
| | | | dimethylpolysiloxane |
| | | Length | 30 m |
| | | Diameter | 0.25 mm |
| | | Film thickness | 0.25 μm |
| | Carrier gas | helium | |
| | Injection volume | 3 μl | |
| | Injector temperature | 250 C. | |
| | Gas flow rate | 0.9 ml/min | |
| | Pressure | 0.47 bar | |
| | Flow rate before | 23.0 ml/min/1 min | |
| | injection | | |
| | Mode | pulsed splitless | |
| | Pressure during | 1.70 bar/1 min | |
| | injection | | |
| | Total flow rate | 53.2 ml/min | |
| | during injection | | |

| | | |
|---|---|---|
| | Oven start | 50 C. for 1.0 min |
| | temperature | |
| | Heating rate | 20 C./min |
| | Oven hold | 150° C. for 1.5 min |
| | temperature | |
| | Oven end | 300° C. for 3.0 min |
| | temperature | |
| Mass- | Temperature | 270° C. |
| sensitive | | |
| detector | | |

All samples, blank solutions and calibrating solutions are extracted in chloroform, and the respective chloroform solutions are then passed for analysis. The blank value has to be ascertained in order to reduce the influence of any impurities and inaccuracies in the analysis. With the respective calibration solutions, a calibration curve is produced by linear regression, and allows the concentration of the sample solutions to be determined. The retention time of ε-caprolactam under these conditions is around 6.3 min. The target ion used is the ion with a mass of 113.0 g/mol, and the verification ions used are the ions with ionic masses of 55.0 and 56.0 g/mol.

Results:

| | Result | |
|---|---|---|
| Sample | Caprolactam elution | |
| Example 1 | <0.05 | mg/l |
| Comparative Example 1 | 1.7 | mg/l |
| Comparative Example 2 | <0.05 | mg/l |

### Gas Barrier Properties

The CO₂ permeability is carried out on a film portion sterilised beforehand at 120° C. in steam for 20 minutes, using a DIN 53380-4 test instrument at 23° C. and 0% relative humidity. All of the films have a permeability of less than 20 cm³/m²*d*bar and are therefore suitable for containing hydrogencarbonate-containing solutions.

### Mechanical Properties

A tensile test is carried out in each case in accordance with DIN EN ISO 527-Part 3, specimen type 2 with a width of 15 mm. The samples are taken from the film with a corresponding punch.

The measurement is conducted at 23° C. and 40-60% atmospheric humidity. The test velocity is 1 mm per min. The modulus of the elasticity is determined—the target value for the modulus of elasticity in manufacturing direction and orthogonally to it is in each case 350 MPa or higher. The results are as follows:

| Sample | Target value achieved or exceeded |
|---|---|
| Example 1 | compliant |
| Comparative Example 1 | compliant |
| Comparative Example 2 | not compliant |

A drop test is carried out additionally on a bag described above, using a mass-produced packaging of the bag according to the product sleep safe BicaVera 5000 ml. The packaging is secured at a height of 60 cm and then caused to fall flatly onto a solid substrate from the predetermined height. 10 samples per example are used, and the percentage fraction of the defects occurring (leakages) is ascertained. Prior to the experiment, the samples are each brought to a temperature of 5° C. The experiment itself is carried out at room temperature within less than 2 minutes following withdrawal from the conditioning chamber.

In the case of Comparative Example 2, a leakage occurred in 80% of the experiments after the drop test. In the case of Example 1 and Comparative Example 1, there is no leakage at the drop height of 60 cm.

Relative to the prior art, the exemplary embodiment exhibits outstanding mechanical robustness in conjunction with extremely low elution values for residual monomers, and so embodiments according to the invention are especially suitable for containing medical fluids, more particular dialysis fluids, and more particularly still dialysis fluids for peritoneal dialysis.

1. A multi-layer gas barrier film for containing medical fluids, comprising an inner film having a first and a second surface, the first surface being in contact with the fluid and the second surface being in contact with a first adhesion agent, a middle film having a third and a fourth surface, the third surface being in contact with the first adhesion agent and the fourth surface being in contact with a second adhesion agent, an outer film having a fifth and sixth surface, the fifth surface being in contact with the second adhesion agent, where the inner film comprises an olefinic polymer having a glass transition point of less than 10° C. and a melting point of above 130° C., where the middle film has a polymer having an ester bond and a glass transition point of above 35° C. and a melting point above 150° C., and the middle film comprises an inorganic gas barrier material, and where the outer film comprises a polymer having an amide bond.

2. The multi-layer gas barrier film according to claim 1, wherein the polymer and the amide bond has a glass transition point of 60 to 100° C. in the dried state and a glass transition point of 20 to 60° C. in the water-saturated state and a melting point greater than 200° C.

3. The multi-layer gas barrier film according to claim 1, wherein the melting point of the polymer having the amide bond has a melting point of less than 250° C.

4. The multi-layer gas barrier film according to claim 1, wherein the polymer with amide bond is an aliphatic polyamide.

5. The multi-layer gas barrier film according to claim 1, wherein the middle film with ester bond has an inorganic gas barrier layer on at least one surface of the polymer and in that the third or fourth surface is formed by the inorganic layer.

6. The multi-layer gas barrier film according to claim 5, wherein the inorganic layer comprises particles of SiOx.

7. The multi-layer gas barrier film according to claim 1, wherein the middle film comprises a polyethylene terephthalate or a polyethylene naphthalate.

8. The multi-layer gas barrier film according to claim 1, wherein the multi-layer film contains no silane coupling agent.

9. The multi-layer gas barrier film according to claim 1, wherein the polymer of the outer film comprises polyamide 6.

10. The multi-layer gas barrier film according to claim 9, wherein the leaching of caprolactam, determined by the method indicated in the description, is less than 1 mg/l.

11. The multi-layer gas barrier film according to claim 1, wherein the inner film has a wall thickness of 100 μm to 250 μm.

12. The multi-layer gas barrier film according to claim 1, wherein the middle film has a wall thickness of 5 μm to 30 μm.

13. The multi-layer gas barrier film according to claim 1, wherein the outer film has a wall thickness of 5 μm to 30 μm.

14. The multi-layer gas barrier film according to claim 1, wherein the sixth surface is in contact with the surrounding atmosphere.

15. The multi-layer gas barrier film according to claim 1, wherein the diffusion of carbon dioxide through the film is less than 20 cm³/m²*d*bar.

16. A bag for containing medical fluids, comprising a multi-layer gas barrier film according to claim 1.

17. The bag according to claim 16, wherein the bag comprises a weld seam.

18. The bag according to claim 16, wherein the bag comprises a peel seam.

19. The multi-layer gas barrier film according to claim 9, wherein the leaching of caprolactam, determined by the method indicated in the description, is less than 0.1 mg/l.
